(19) United States
(12) Patent Application Publication
(10) Pub. No.: US 2008/0117006 A1
(43) Pub. Date: May 22, 2008

(54) Switching Equipment Comprising a Thermal and Electromagnetic Trip Device

(76) Inventors: Patrick Claeys, Darmstadt (DE); Albrecht Vogel, Stutensee (DE)

Correspondence Address: BUCHANAN, INGERSOLL & ROONEY PC, POST OFFICE BOX 1404, ALEXANDRIA, VA, 22313-1404, US

(21) Appl. No.: 11/667,835

(22) PCT Filed: Nov. 15, 2005
(86) PCT No.: PCT/EP05/12189

§ 371 Date: May 16, 2007

(30) Foreign Application Priority Data
Nov. 22, 2004 (DE) 10 2004 056 278.4

(51) Int. Cl. H01H 75/12

(52) U.S. Cl. 335/35

(57) ABSTRACT

A switching device has a housing and at least one contact point, which comprises a fixed contact piece and a moveable contact piece, and having a thermal and magnetic release, which comprises a tripping coil and a tripping armature. The tripping armature comprises at least two operatively connected tripping armature parts. The first tripping armature part is formed from a first material having a magnetic shape memory effect. The second tripping armature part is formed from a bimetallic strip or from a material having a thermal shape memory effect or from a material having a combined thermal and magnetic shape memory effect. The tripping armature, both under the influence of the magnetic field of the tripping coil in the event of a short-circuit current and under the influence of an increase in temperature brought about by overcurrent, can be deformed and, as a result, the contact point can be caused to open. Uses of a material having a magnetic shape memory effect in a thermal and electromagnetic release are also disclosed.

The invention relates to a switching device having a housing and having at least one contact point, which comprises a fixed contact piece and a moveable contact piece, and having a thermal and magnetic release having a tripping coil and a tripping armature, which opens the contact point, in accordance with the precharacterizing clause of claim 1. Furthermore, the invention relates to the use of a material having a magnetic shape memory effect in a thermal and electromagnetic release having a tripping coil and a tripping armature for a switching device in accordance with the precharacterizing clause of claim 13 and also to the use of a material having a magnetic shape memory effect for overcurrent and short-circuit current tripping in a switching device comprising a contact point and a thermal and electromagnetic release in accordance with the precharacterizing clause of claim 16.

In generic switching devices, for example line circuit breakers or motor circuit breakers, the electromagnetic release is used for interrupting the current path between the input and output terminals in the event of the occurrence of a short-circuit current. The thermal release is used for interrupting the current path for the case in which an overcurrent occurs which exceeds the rated current by a specific amount and for over a specific amount of time. The electromagnetic releases known nowadays in the prior art, such as are described, for example, in DE 101 26 852 C1 or DE 100 10 093 A1, in this case all function on the basis of the principle that a tripping armature caused to move towards a magnet core in the event of the occurrence of a short-circuit current and, in the course of this movement, the tripping armature, via a plunger which is operatively connected to it, forces the moveable contact piece away from the fixed contact piece at the contact point, with the result that the contact point is opened. Known electromagnetic releases comprise for this purpose a coil, which is generally produced from helically wound wire, and a magnet core, which is fixedly connected to a yoke surrounding the coil on the outside and engages in the interior of the coil. The tripping armature is either in the form of a hinged armature or in the form of a plunger-type armature, the latter likewise being located within the coil. The armature is held at a distance from the core in the rest state by means of a compression spring. If the short-circuit current flows through the tripping coil, the magnetic field induced in the process in the tripping coil results in the tripping armature being moved towards the core counter to the resetting force of the compression spring. Once the short-circuit current has been switched off, the armature is moved back into its initial position again by the resetting force of the compression spring.

Thermal releases known in the prior art generally operate with tripping elements consisting of a bimetallic strip or thermal shape memory metals which are realized as a flexural bar or as a snap-action disk, for example. DE 43 00 909 A1 has disclosed a thermal release having a bimetallic flexural bar.

Thermal and magnetic releases nowadays comprise a first, thermal release part having a thermal tripping armature consisting of a bimetallic strip or thermal shape memory metal, as mentioned above, and a second, magnetic release part having a tripping coil and a magnetic tripping armature. DE 42 42 516 A1 has disclosed a combined thermal and magnetic release, in the case of which the thermal release part is in the form of a snap-action disk and the electromagnetic release part is formed by an impact armature release. However, in this case too, two separate releases are constructed which are combined physically next to one another in a complex assembly.

The design of thermal and electromagnetic releases is therefore nowadays very complex and associated with high costs since two complete releases need to be constructed and combined with one another, in which case many individual parts need to be manufactured and assembled with exacting tolerances.

It is therefore the object of the present invention to design a generic switching device in a manner which is simpler to fit and therefore more cost-effective.

The object is achieved by a switching device having the characterizing features of claim 1, by the use of a material having a combined thermal and magnetic shape memory effect in a switching device in accordance with the characterizing features of claim 13 and by the use of a material having a combined thermal and magnetic shape memory effect for short-circuit current tripping and overcurrent tripping in a switching device in accordance with the characterizing features of claim 16.

According to the invention, the tripping armature therefore comprises two operatively connected tripping armature parts, and a first tripping armature part is formed from a first material having a magnetic shape memory effect, and a second tripping armature part is formed from a bimetallic strip or from a material having a thermal shape memory effect or from a material having a combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open.

In the case of magnetic shape memory alloys, a change in shape may be brought about in the martensitic phase owing to the transition between two crystal structure variants of a twin-crystal structure, in which case the transition between the crystal structure variants is controlled by an external magnetic field. These materials are therefore referred to as magnetic shape memory alloys (MSMs).

In the case of the known thermal shape memory alloys (TSM), for example based on Ni—Ti, the two shapes between which the component changes are in different phases of the material: a martensitic phase below and an austenitic phase above a so-called transition temperature of the material. If the material temperature exceeds the transition temperature, the phase transition takes place, which brings with it the change in shape.

In this regard the thermal shape memory alloys differ from the likewise known bimetallic strips in terms of their operation. A bimetallic sheet comprises two metal sheets having different coefficients of thermal expansion which are welded to one another. On heating, one side of the bimetallic strip expands more severely than the other, with the result that the bimetallic sheet overall bends in the direction of the material with the lower coefficient of thermal expansion.

Magnetic shape memory alloys are advantageously in the form of ferromagnetic shape memory alloys consisting of nickel, manganese and gallium. More precise explanations in relation to the design and function of ferromagnetic shape memory alloys on the basis of nickel, manganese and gallium can be gleaned, for example, from WO 98/08261 and WO 99/45631.

By means of the corresponding alloy composition it is possible to determine at which orientation of the external magnetic field the maximum expansion is achieved; for example the magnetic field may be at right angles to or transverse to the MSM material in order to reach the maximum expansion.

Changes in shape which are achieved by MSM materials under the effect of an external magnetic field may be linear expansion, bending or torsion.

In the case of MSM materials, in addition to the magnetically stimulated transition, a thermally stimulated transition also takes place between the martensitic and austenitic phase.

If the external magnetic field is sufficiently small, these materials behave as a conventional thermal shape memory metal. In this case, the thermal transition temperature can be determined by the corresponding alloy composition and can therefore be matched to the respective application.

In the case of MSM materials, one of the above-mentioned changes in shape can therefore be brought about below the transition temperature, in the low-temperature or martensitic phase, exclusively by applying an external magnetic field. Without an external magnetic field, or in the case of a very small external magnetic field, the change in shape takes place in a thermally induced manner when the temperature exceeds or falls below the transition temperature.

The advantage of the invention consists in the fact that, in the case of a switching device according to the invention, both tripping principles, namely the thermal tripping principle and the electromagnetic tripping principle, are realized in a single tripping element having a low degree of complexity. The design of a thermal and magnetic release is therefore significantly simplified. The thermal and magnetic release according to the invention can also be realized in a significantly more compact and space-saving manner than a combination of two separate thermal and magnetic releases in accordance with the prior art. A switching device according to the invention having a thermal and magnetic release according to the invention can therefore also have a simpler and more compact design.

One further advantage of a switching device according to the invention is the high speed of the magnetic tripping. No inert masses need to be accelerated, and the change in shape owing to the magnetic shape memory effect takes place virtually without delay.

A further advantage is the fact that it is possible to achieve a high degree of actuating power given a relatively large change in length owing to the high degree of conversion efficiency from magnetic energy to mechanical energy in the case of ferromagnetic shape memory alloys.

In the switching device according to the invention the magnetic field is produced for the electromagnetic tripping by a coil through which current flows.

In one advantageous embodiment of the invention, the first and second tripping armature parts are formed from ferromagnetic shape memory alloys consisting of nickel, manganese and gallium and each having different compositions.

The first, magnetic and second, thermal tripping armature parts can advantageously be in the form of elongate components, the first tripping armature part, under the influence of the magnetic field of the tripping coil in the event of a short-circuit current, and the second tripping armature part, under the influence of an increase in temperature brought about by overcurrent, being extended in the direction of their longitudinal axis. The first tripping armature part is connected, for example, to the second tripping armature part in an interlocking manner, with the result that, overall, a two-part tripping armature is formed, one of whose parts consists of the thermal shape memory material and the other of whose parts consists of the magnetic shape memory material. Other types of operative connection between the magnetic and the thermal armature are also conceivable. It is important that the second, thermal and the first, magnetic armature parts can both change their shape independently of one another, with the result that the tripping armature can overall have both a magnetically activated and a thermally activated effect on the contact point of the service switching device.

The first and second tripping armature parts can also be in the form of bars, the first tripping armature part, under the influence of the magnetic field of the tripping coil in the event of a short-circuit current, and the second tripping armature part, under the influence of an increase in temperature brought about by overcurrent, being bent. The first tripping armature part can in this case consist of a strip of a ferromagnetic shape memory alloy, to whose broad side a bimetallic strip can be attached in an interlocking manner.

One further advantageous, possible embodiment is designed such that the first and second tripping armature parts are helical, the first tripping armature part, under the influence of the magnetic field of the tripping coil in the event of a short-circuit current, and the second tripping armature part, under the influence of an increase in temperature brought about by overcurrent, being extended in the direction of the longitudinal axis of the helix.

The tripping armature can in this case be operatively connected, at its second end, to a plunger. The tripping armature according to the invention and consisting of a ferromagnetic shape memory metal is also easier to mount than the tripping armature in conventional releases. This is because, in the latter case, the tripping armature needs to be mounted such that it can move slightly, whereas, in releases according to the invention, it does not have any moveable parts any more and, in one advantageous embodiment, is mounted fixedly at a first end, it expanding or bending at its second, moveable end under the influence both of the magnetic field and of an increase in temperature induced by overcurrent. Here, a particularly advantageous embodiment is one in which the tripping armature is held at a first, fixed end in a mount, which is connected to the housing.

In one advantageous embodiment of the thermal and magnetic release according to the invention, the increase in temperature of the tripping armature, in particular of the second, thermal tripping armature part, is brought about in the event of an overcurrent by means of indirect heating. For this purpose, the overcurrent flows through, for example, the tripping coil, in whose vicinity the tripping armature is fitted. When the coil is heated owing to overcurrent, the tripping armature, in particular the second, thermal tripping armature part, is indirectly and concomitantly heated by thermal radiation.

One further advantageous embodiment is characterized by the fact that the increase in temperature of the tripping armature, in particular of the second, thermal tripping armature part, is brought about in the event of an overcurrent by means of direct heating. In this case, the overcurrent flows directly through the tripping armature and, owing to the resistance heating induced by the current flow, the tripping armature, in particular the second, thermal tripping armature part, is heated.

One significant advantage of a switching device according to the invention consists in the fact that the physical assignment of the tripping coil to the tripping armature consisting of a ferromagnetic shape memory metal can be matched in a variety of ways to the geometrical requirements within the switching device housing. In one advantageous embodiment, the tripping armature can thus be surrounded by the tripping coil. In accordance with a further advantageous embodiment, the tripping armature can be fitted outside the coil in its vicinity.

An additional further thermal tripping element is not required.

Optimum utilization of space can therefore be achieved within the switching device housing, which results in smaller and therefore more cost-effective designs of the switching devices.

Fewer parts are required with a lower demand on their measurement accuracy for the thermal and electromagnetic release, and it is therefore simpler and less expensive to fit a thermal and electromagnetic release with a tripping armature consisting of a ferromagnetic shape memory metal.

Further advantageous refinements and improvements of the invention and further advantages are given in the further dependent claims.

The invention and further advantageous refinements of the invention will be explained and described in more detail with reference to the drawings, in which five exemplary embodiments of the invention are illustrated and in which:

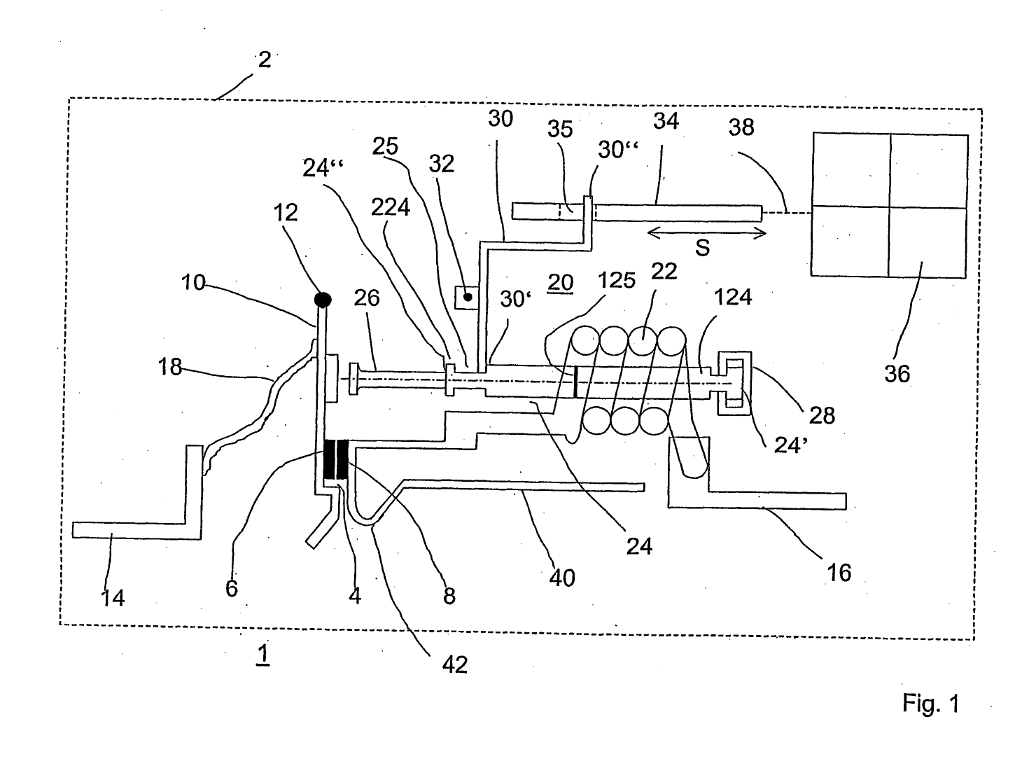

FIG. 1 shows a schematic illustration of a first embodiment of a switching device according to the invention having a rod-shaped tripping armature, formed from a first, magnetic tripping armature part consisting of a ferromagnetic shape memory metal and a second, thermal tripping armature part consisting of a thermal shape memory metal, arranged in the interior of a tripping coil, in the rest state,

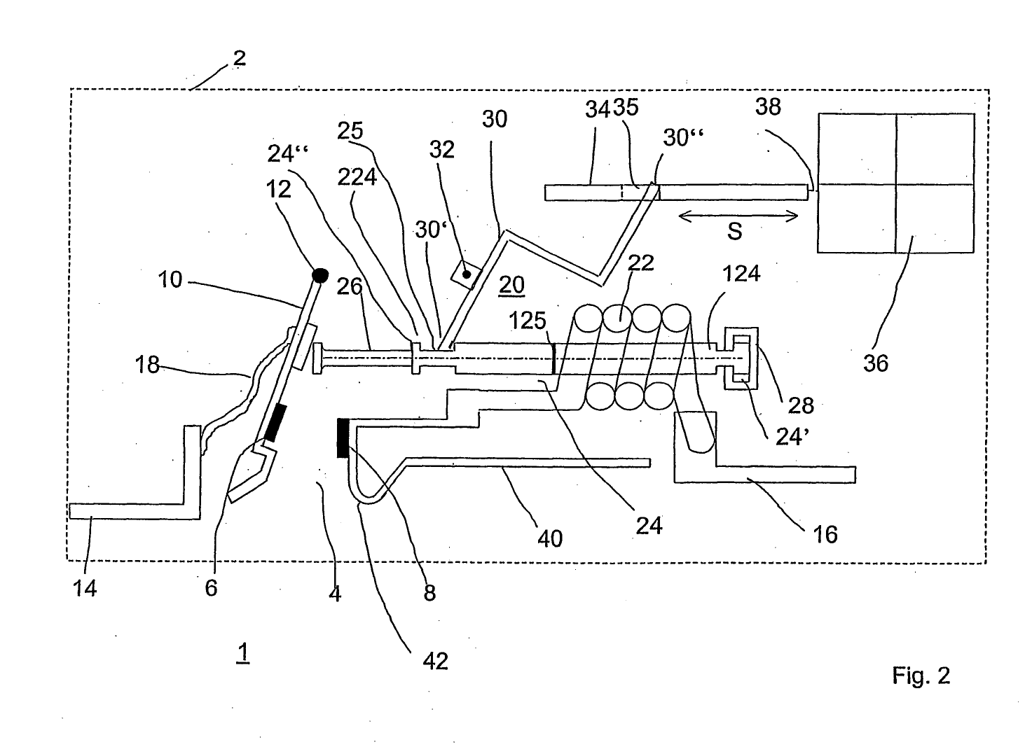

FIG. 2 shows a schematic illustration of the first embodiment shown in FIG. 1 in the tripped state,

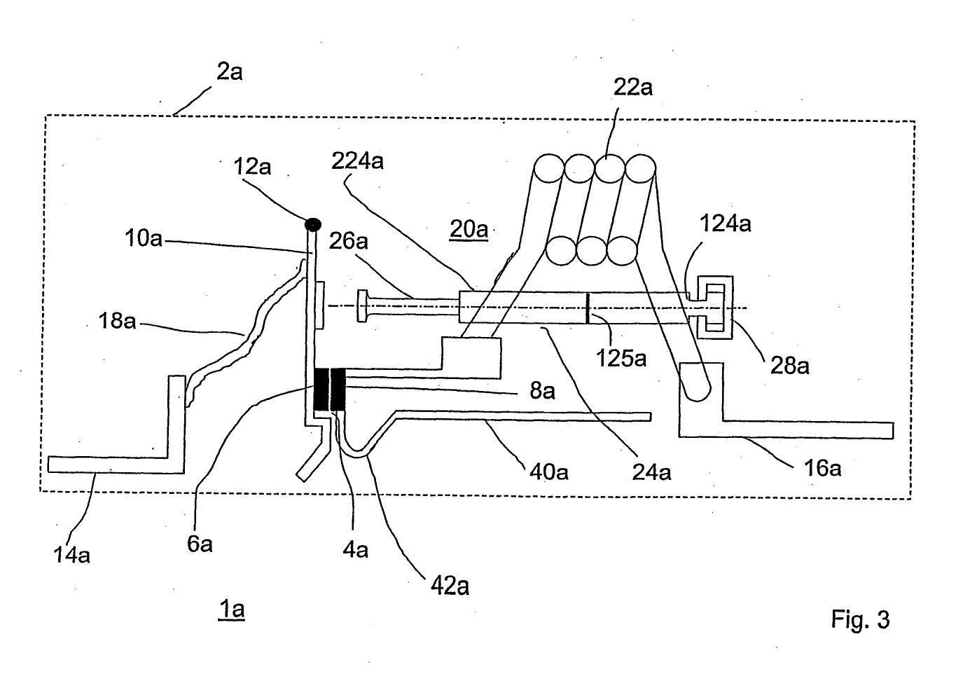

FIG. 3 shows a schematic illustration of a second embodiment of a switching device according to the invention having a rod-shaped tripping armature, formed from a first, magnetic tripping armature part consisting of a ferromagnetic shape memory metal and a second, thermal tripping armature part consisting of a thermal shape memory metal, arranged adjacent to a tripping coil, in the rest state,

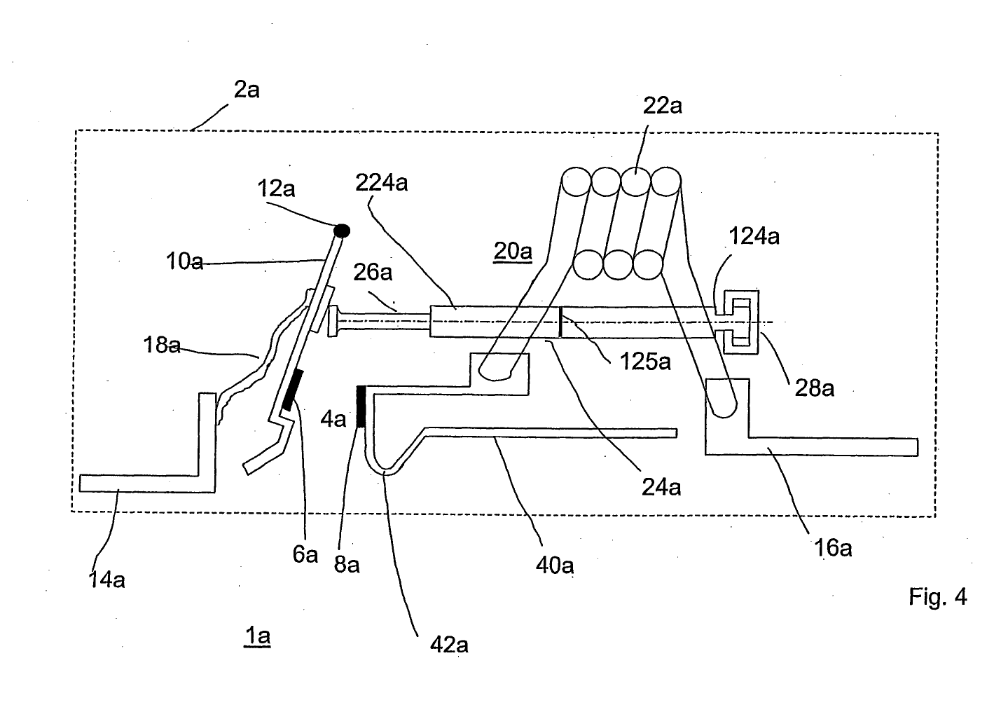

FIG. 4 shows a schematic illustration of the second embodiment shown in FIG. 3 in the tripped state,

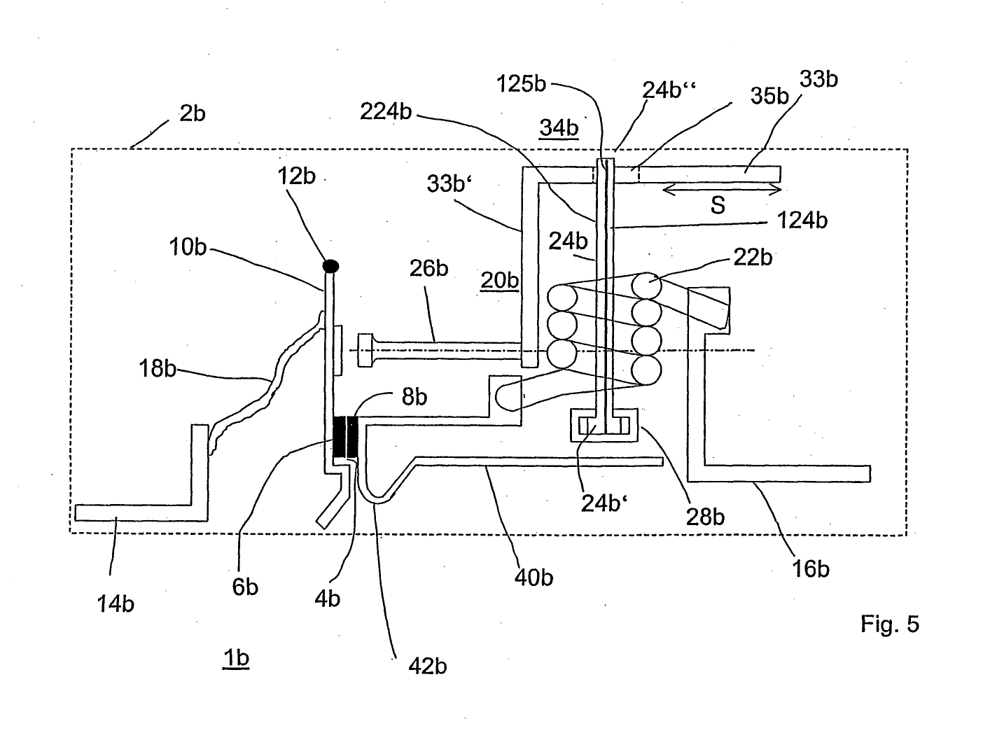

FIG. 5 shows a schematic illustration of a third embodiment of a switching device according to the invention having a tripping armature which is in the form of a flexural bar clamped in at one end, is formed from a first, magnetic tripping armature part consisting of a strip of magnetic shape memory metal and a second, thermal tripping armature part consisting of a bimetallic strip, and is arranged in the interior of a tripping coil, in the rest state,

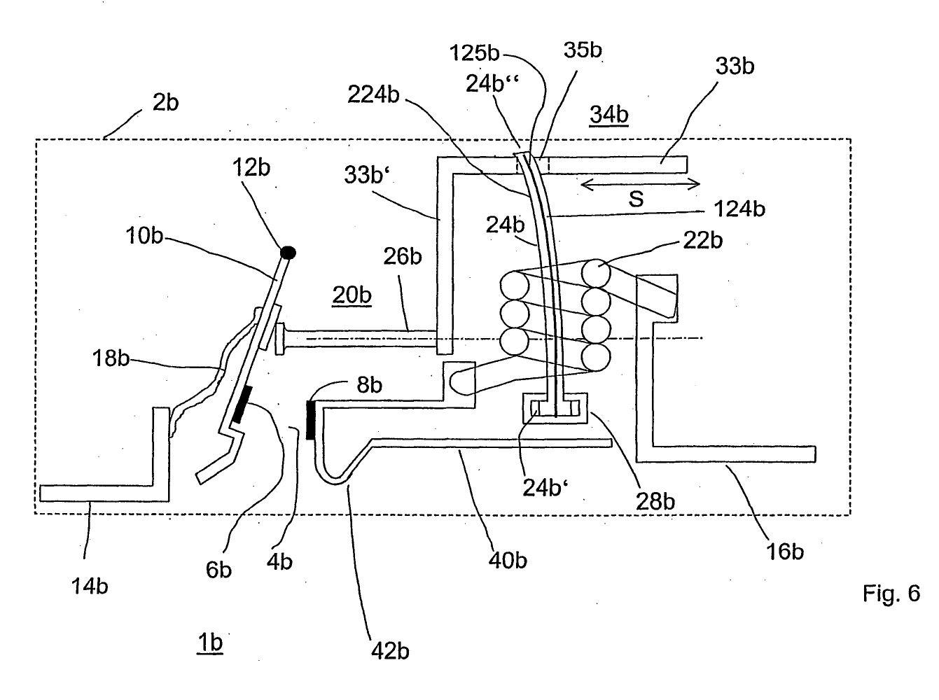

FIG. 6 shows a schematic illustration of the third embodiment shown in FIG. 5 in the tripped state,

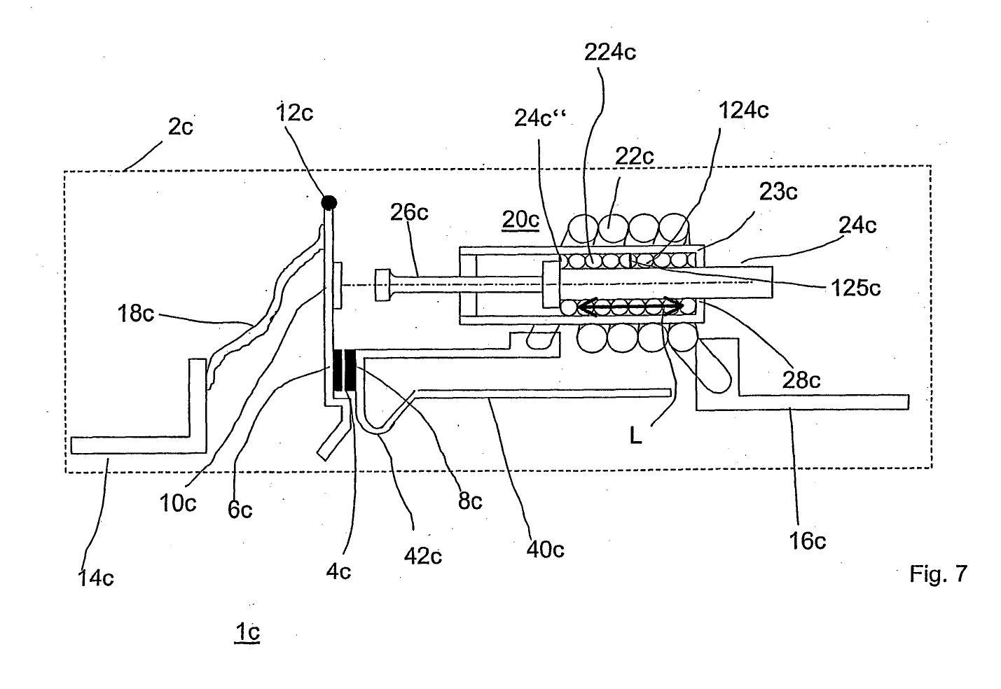

FIG. 7 shows a schematic illustration of a fourth embodiment of a switching device according to the invention having a helical tripping armature, formed from a first, magnetic tripping armature part consisting of a helix of magnetic shape memory metal and a second, thermal tripping armature part consisting of a bimetallic spiral, and is arranged in the interior of a tripping coil, in the rest state,

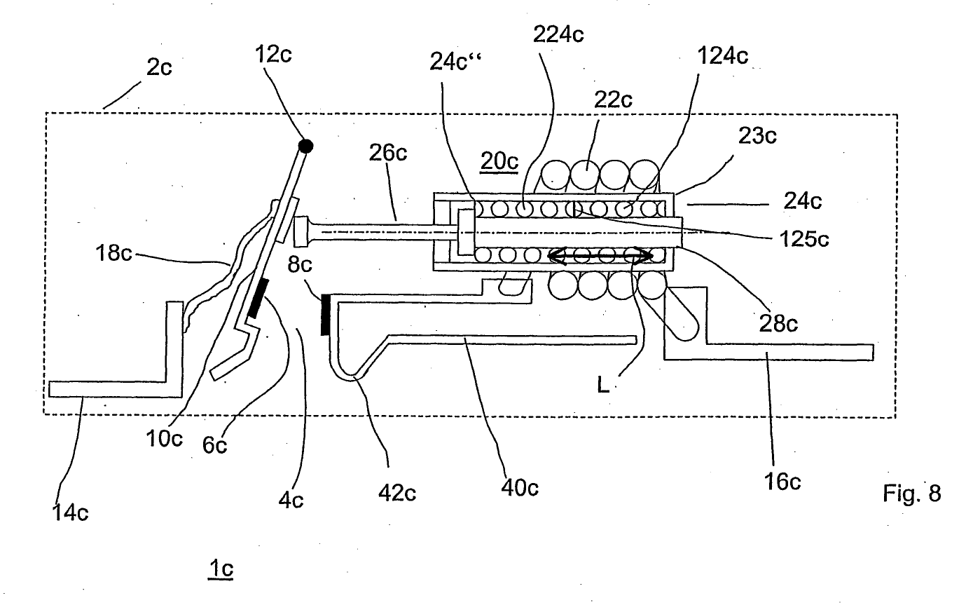

FIG. 8 shows a schematic illustration of the fourth embodiment shown in FIG. 7 in the tripped state,

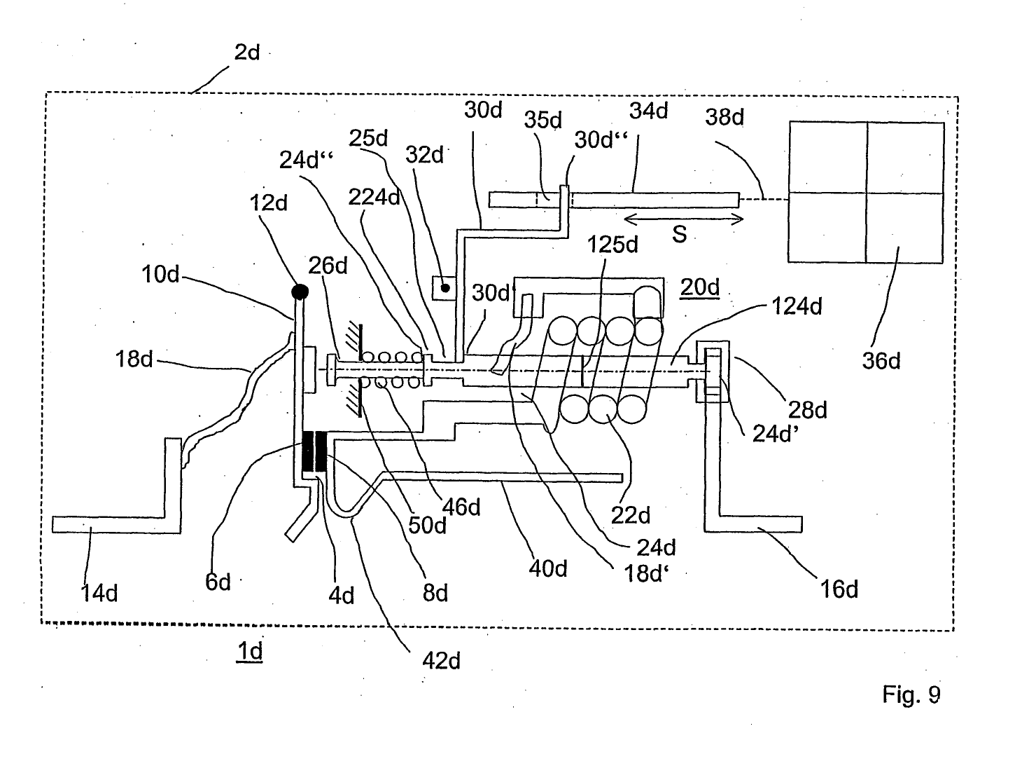

FIG. 9 shows a schematic illustration of a fifth embodiment of a switching device according to the invention having a rod-shaped tripping armature through which current flows, formed from a first, magnetic tripping armature part consisting of a ferromagnetic shape memory metal and a second, thermal tripping armature part consisting of a thermal shape memory metal, arranged in the interior of a tripping coil, in the rest state, and

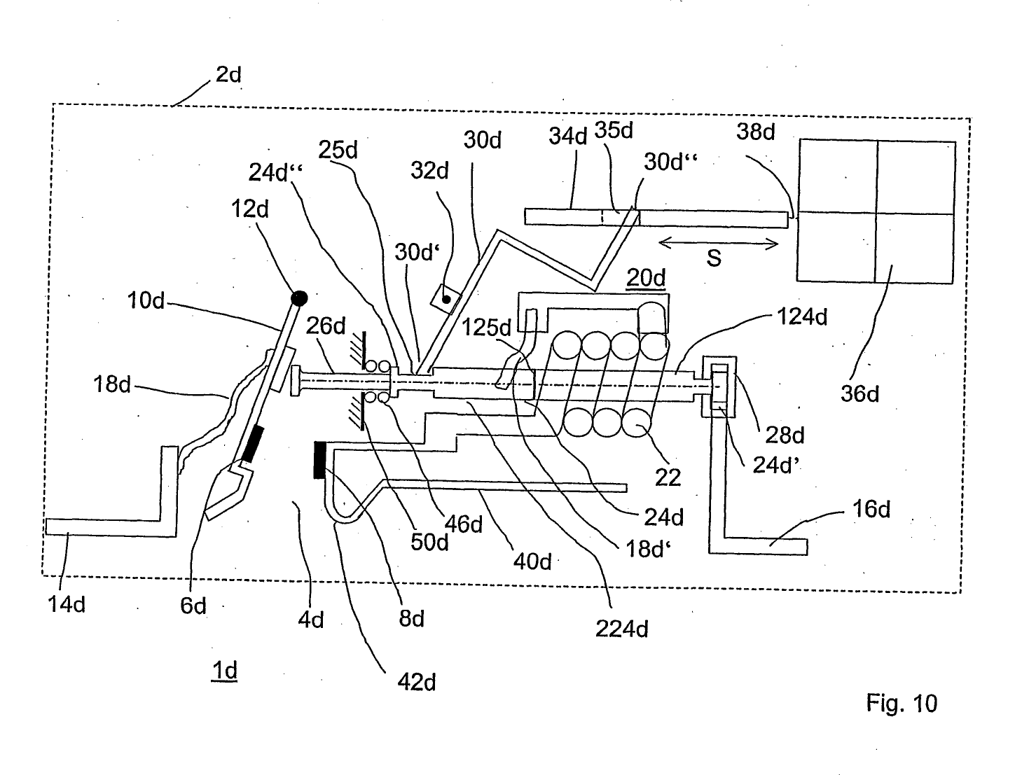

FIG. 10 shows a schematic illustration of the fifth embodiment shown in FIG. 9 in the tripped state.

FIG. 1 shows a schematic illustration of a switching device 1 having a housing 2, a thermal and electromagnetic release 20 and a switching mechanism 36 in the untripped state. FIG. 2 shows the switching device shown in FIG. 1 in the tripped state, in which case identical or functionally similar modules or parts are denoted by the same reference numerals.

A current path runs between an input clamping piece 14 and an output clamping piece 16 via a moveable braided wire 18, a contact lever 10 mounted in a contact-lever mount 12, a contact point 4 comprising a moveable contact piece 6 located on the contact lever 10 and a fixed contact piece 8, and a tripping coil 22. In the switching position shown in FIG. 1, the contact point 4 is closed. A yoke 40 is also connected to the tripping coil 22 and the fixed contact piece 8 via a lug-shaped intermediate piece 42.

The thermal and electromagnetic release 20 comprises the tripping coil 22 and a tripping armature 24, which in this case is in the form of a bar and is arranged in the interior of the tripping coil 22 such that the longitudinal axis of the coil and the longitudinal axis of the tripping armature coincide.

The tripping armature 24 is formed from a first, magnetic tripping armature part 124 and a second, thermal tripping armature part 224, which are connected to one another at a connection point 125. The nature of the connection may be interlocking, force-fitting or one produced by techniques such as soldering, bonding or welding.

At a first, fixed end 24′, the first, magnetic tripping armature part 124 is held in a tripping-armature mount 28, which is connected to the housing 2. At its second, free end 24″, the second, thermal tripping armature part 224 is operatively connected to a plunger 26. The operative connection is shown here as an interlocking connection, but force-fitting connections or connections produced by techniques such as soldering, bonding or welding could also alternatively be realized.

At its free end 24′, the second, thermal tripping armature part 224 has a notch 25 in which a tripping lever 30, which is mounted in a tripping-lever mount 32, engages, for example with a fork located at its first free end 30′. The second free end 30″ of the tripping lever 30 engages in a cutout 35 in a slide 34, which is operatively connected to the switching mechanism 36 via a line of action 38.

The first, magnetic tripping armature part 124 consists of a ferromagnetic shape memory metal having a magnetic shape memory effect based on nickel, manganese and gallium. Such ferromagnetic shape memory alloys are known in principle and are available; they are produced and marketed, for example, by the Finnish firm AdaptaMat Ltd. A typical composition of ferromagnetic shape memory alloys for the use according to the invention in switching devices is provided by the structural formula Ni_{65-x-y}Mn₂₀₊ₓGa_{15+y}, where x is between 3 atomic percent and 15 atomic percent, and y is between 3 atomic percent and 12 atomic percent.

The ferromagnetic shape memory alloy used here has the property that, in its martensitic phase, that is the phase which the material assumes below the thermal transition temperature, under the influence of an external magnetic field on a microscopic scale a transition between two crystal structure variants of a twin-crystal structure takes place which is macroscopically connected to a change in shape. In the embodiment selected here for the tripping armature, the change in shape consists in a linear extension in the direction of the longitudinal axis of the bar.

The second, thermal tripping armature part 224 in this case consists, for example, of a thermal shape memory alloy, which is known in principle, based on nickel-titanium. In the case of such a material, it is known that when the thermal transition temperature is exceeded, the thermal shape memory material—even without an external magnetic field—transfers from its martensitic to its austenitic phase. This phase transition is reversible and is likewise associated with a change in shape, which in this case likewise manifests itself as a change in length of the second, thermal tripping armature part 224, which is in the form of a bar.

However, the second, thermal tripping armature part 224 can also be formed from a ferromagnetic shape memory alloy based on nickel, manganese, gallium which differs in terms of its composition from that used in the first, magnetic tripping armature part owing to its transition temperature. The thermal transition temperature in the case of the ferromagnetic shape memory alloys used here is in the region of the ambient temperature and can be adjusted by varying the atomic percent proportions x and y within a bandwidth. The working temperature range within which the thermal and magnetic release operates as a purely magnetic release can therefore be adjusted within a bandwidth by selecting the material composition.

When the thermal transition temperature is exceeded, the ferromagnetic shape memory material—even without an external magnetic field—transfers to its austenitic phase and in this regard has a similar response to a conventional thermal shape memory metal based on nickel and titanium. The ferromagnetic shape memory alloy of the first, magnetic tripping armature part 124 is accordingly composed such that an effective magnetic interaction is ensured, whereas the ferromagnetic shape memory alloy of the second, thermal tripping armature part 224 is selected such that the thermal transition temperature is within the desired range, without regard to the efficiency of the magnetic interaction.

Short-circuit current tripping now takes place in the following manner. If a high short-circuit current flows through the switching device 2 in the event of a short circuit, the first, magnetic tripping armature part 124 expands owing to the above-described magnetic shape memory effect. The second, thermal tripping armature part 224 does not change in length, but is carried along by the expanding first, magnetic tripping armature part 124 and, as a result, the plunger 26 forces the moveable contact piece 6 away from the fixed contact piece 8, with the result that the contact point 4 is opened and the switching device is tripped, as illustrated in FIG. 2. The expansion of the ferromagnetic shape memory material takes place in this case very rapidly and virtually without any delay. The delay time as the time difference between the occurrence of the short-circuit current and the maximum length expansion of the tripping armature 24 is typically of the order of magnitude of one millisecond.

Tripping is in this case assisted by the tripping lever 30, which rotates in the clockwise direction about the tripping-lever mount 32 when the tripping armature 24 expands and in the process displaces the slide 34 in the direction of its longitudinal extent, indicated by the directional arrow S, with the result that the slide 34 actuates the switching mechanism 36 via the line of action 38, and this switching mechanism holds the contact point open permanently via operative connections (not illustrated here).

Once the switching device has been tripped, the current path is interrupted and the magnetic field of the tripping coil 22 breaks down again. As a result, the first, magnetic tripping armature part 124 will again contract to its initial dimensions and in the process carry along the second, thermal tripping armature part, as a result of which the tripping lever 30 is also moved back into the initial position again, as shown in FIG. 1. The contact point 4 is now held permanently in the open position by the switching mechanism 36 owing to the operative connections (not illustrated here).

Thermal overcurrent tripping takes place in the following manner: if the current flowing in the current path through the switching device 1 exceeds its rated value by a higher value and for a longer period of time than is permitted, the second, thermal tripping armature part 224 is heated, owing to the heat input from the tripping coil 22, to a temperature which is above the thermal transition temperature of the thermal shape memory metal. As a result, the thermally induced change in shape of the second, thermal tripping armature part 224 takes place, which in this case likewise manifests itself as a linear expansion. The first, magnetic tripping armature part 124 does not change in terms of its length since the magnetic field in the event of an overcurrent is insufficient for this purpose. Owing to the expansion of the second, thermal tripping armature part 224 and as a result of the engagement of its first free end 30′, the tripping lever 30 rotates in the clockwise direction about the tripping-lever mount 32 and in the process displaces the slide 34 in the direction of its longitudinal extent, indicated by the directional arrow S, with the result that the slide 34 actuates the switching mechanism 36 via the line of action 38, and this switching mechanism opens the contact point via operative connections (not illustrated here) and holds it open permanently.

Electromagnetic and thermal tripping are therefore brought about by a single functional component, which is formed from two functionally different, interacting zones. The design of a switching device with a thermal and magnetic release as described is therefore very simple and, owing to the fact that a complete assembly is dispensed with, is more cost-effective than in the case of conventional switching devices.

FIG. 3 shows a further embodiment of a switching device 1a according to the invention in the untripped state, and FIG. 4 shows the switching device 1a in the tripped state. Identical or functionally identical components and parts are denoted by the same reference numerals as in FIGS. 1 and 2, supplemented by the letter a. The essential difference between the switching device 1a shown in FIGS. 3 and 4 and the switching device 1 shown in FIGS. 1 and 2 consists in the fact that, in the former case, the tripping armature 24a having the first, magnetic tripping armature part 124a and the second, thermal tripping armature part 224a is arranged outside the tripping coil 22a. In addition, the tripping lever 30a, the slide 34a and the switching mechanism 36a are not illustrated in FIGS. 3 and 4 for reasons of clarity.

In the event of a short-circuit current, the change in shape of the first, magnetic tripping armature part 124a in the embodiment shown in FIGS. 3 and 4 is brought about by the magnetic field in the outer region of the tripping coil 22a. A corresponding design of the tripping coil 22a and the magnetic circuit can be carried out by a person skilled in the art using his normal knowledge in the art and assisted by systematic experiments. In the event of a thermal overload, the second, thermal tripping armature part 224 is likewise heated by the heat input from the tripping coil 22.

FIG. 5 shows a further embodiment of a switching device 1b according to the invention in the untripped state, and FIG. 6 shows the switching device 1b in the tripped state. Identical or functionally identical components and parts are denoted by the same reference numerals as in the case of the switching device 1 in FIGS. 1 and 2, supplemented by the letter b. The essential difference between the switching device 1b shown in FIGS. 5 and 6 and the switching device 1 shown in FIGS. 1 and 2 consists in the fact that, in the former case, the tripping armature 24b having the first, magnetic tripping armature part 124b and the second, thermal tripping armature part 224b is in the form of a flexural bar. The first, magnetic tripping armature part 124b is in the form of a sheet-metal strip consisting of a ferromagnetic shape memory alloy. The second, thermal tripping armature part 224b is in the form of a sheet-metal strip consisting of a thermal shape memory alloy or of a bimetallic strip known per se. The two sheet-metal strips of the first, magnetic tripping armature part 124b and of the second, thermal tripping armature part 224b are connected to one another on a broad side in an interlocking or force-fitting manner or by techniques such as soldering, bonding or welding, such that bending of one of the two tripping armature parts bends to the tripping armature 24b as a whole. With a first, fixed end 24b′, the tripping armature 24b is clamped in fixedly at one end at the tripping armature bearing point 28b, with the result that it overall acts as a flexural bar. The tripping armature 24b is arranged in the interior of the tripping coil 22b. The change in shape induced by the magnetic field of the tripping coil 22b in the event of a short circuit in this case consists in bending of the first, magnetic tripping armature part 124b, and the change in shape induced by an increase in temperature owing to thermal radiation from the tripping coil 22b in this case consists in bending of the second, thermal tripping armature part 224b, in each case at the second, free end 24b″, see FIG. 6. The second, free end 24b″ of the tripping armature 24b engages in a cutout 35b in a first limb 33b of the L-shaped slide 34b, as a result of which said slide is displaced when the tripping-armature 24b is bent in the direction of the longitudinal extent of the first limb 33b, indicated by the directional arrow S. At its second limb 33b′, the slide 34b is operatively connected to the plunger 26b, which forces the moveable contact 6b away from the fixed contact 8b when the slide 34b is displaced and thus opens the contact point 4b. The switching mechanism 36 is not illustrated in the embodiment in FIGS. 5 and 6 for reasons of clarity.

FIG. 7 shows a further embodiment of a switching device 1c according to the invention in the untripped state, and FIG. 8 shows the switching device 1c in the tripped state. Identical or functionally identical components and parts are denoted by the same reference numerals as in the case of the switching device 1 in FIGS. 1 and 2, supplemented by the letter c. The essential difference between the switching device 1c shown in FIGS. 7 and 8 and the switching device 1 shown in FIGS. 1 and 2 consists in the fact that, in the former case, the tripping armature 24c is helical and is guided in the interior of the tripping coil 24c in a guide sleeve 23c, which is aligned parallel to the axis of the coil. It is formed from a first, magnetic tripping armature part 124c and a second, thermal tripping armature part 224c. Both tripping armature part helices 124c and 224c are arranged one behind the other and are connected to one another at the connection point 125c in an interlocking or force-fitting manner or by techniques such as soldering, bonding or welding. The first, magnetic tripping armature part helix 124c consists of a ferromagnetic shape memory alloy having a magnetic shape memory effect and based on nickel, manganese and gallium. The second, thermal tripping armature part helix 224c in this case consists, for example, of a thermal shape memory alloy, which is known in principle, consisting of nickel-titanium, or consists of a bimetallic strip.

The change in shape of the helical tripping armature 24c induced by the magnetic field of the tripping coil 22c in the event of a short circuit or by an increase in temperature of the tripping armature 24c owing to thermal radiation from the tripping coil 22c in this case consists in the first case in an expansion of the first, magnetic tripping armature part helix 124c, as a result of which the second, thermal tripping armature part helix 224c is also concomitantly displaced, or, in the second case, in an expansion of the second, thermal tripping armature part 224c, and therefore in each case in an integral expansion of the helices 24c forming the tripping armature in the direction of the longitudinal axis of the helices, indicated by the directional arrow L. At the moveable end 24c″ of the helical tripping armature 24c, it is operatively connected to the plunger 26c, which, in the event of tripping, opens the contact point 4c, see FIG. 8. The switching mechanism and its lines of operative connection with the tripping armature 24c and the contact point 4c are not illustrated here for reasons of clarity.

FIG. 9 shows a further embodiment of a switching device 1d according to the invention in the untripped state, and FIG. 10 shows the switching device 1d in the tripped state. Identical or functionally identical components and parts are denoted by the same reference numerals as in the case of the switching device 1 in FIGS. 1 and 2, supplemented by the letter d.

The embodiment shown in FIG. 9 differs from that shown in FIG. 1 by virtue of the fact that, in the former case, heating of the tripping armature 24d takes place directly by current flow and not, as in the latter case, indirectly via thermal radiation from the tripping coil 22d. The current path in the embodiment shown in FIG. 9 is as follows: the current flows from the input terminal 14d via the moveable braided wire 18d, the contact lever 10d, the contact point 4d through the tripping coil 22d and on in series to this via a further moveable braided wire 18d′, which connects the end of the tripping coil 22d electrically to the second, thermal tripping armature part 224d, through said tripping armature part 224d and the first, magnetic tripping armature part 124d and from the fixed end 24d′ thereof on to the output terminal 16d. In the event of an overcurrent, the first, thermal tripping armature part 224d is therefore heated directly by Joulean heat. As a result, a thermally more precise design of the thermal and magnetic release 20d is possible.

In order to assist in the back-deformation of the tripping armature 24d after tripping—in the event of a short-circuit current once the magnetic field of the tripping coil 22d has broken down or in the event of an overcurrent once the tripping armature 24d has been cooled to a temperature below the thermal transition temperature as a result of the contact opening—in the embodiment shown in FIGS. 9 and 10 a resetting spring 46d is provided. In this case, this resetting spring is in the form of a helical spring and surrounds the plunger 26d. However, it could also be in the form of a leaf spring or have another suitable design. The resetting spring is unstressed in the untripped state (FIG. 9). It is supported with one end on a spring mount 50d, which is connected to the housing, and with its other end on the moveable end 24d″ of the tripping armature 24d. In the event of tripping (FIG. 10), it is compressed by the expanding tripping armature 24d.

The exemplary embodiments described and illustrated in FIGS. 1 to 10 are an exemplary, non-exclusive representation of possible switching devices according to the invention using a thermal and electromagnetic release having a tripping armature comprising a first, magnetic tripping armature part and a second, thermal tripping armature part. It is also possible for switching devices according to the invention to be produced from all other switching device variants known in the prior art having thermal and electromagnetic releases by the use according to the invention of a ferromagnetic shape memory alloy in a first, magnetic tripping armature part of a tripping armature formed from a first, magnetic tripping armature part and a second, thermal tripping armature part.

### LIST OF REFERENCE SYMBOLS

1, 1a, 1b, 1c, 1d Switching device
2, 2a, 2b, 2c, 2d Housing
4, 4a, 4b, 4c, 4d Contact point
6, 6a, 6b, 6c, 6d Moveable contact piece
8, 8a, 8b, 8c, 8d Fixed contact piece
10, 10a, 10b, 10c, 10d Contact lever
12, 12a, 12b, 12c, 12d Contact-lever mount
14, 14a, 14b, 14c Input terminal
16, 16a, 16b, 16c Output terminal
18, 18a, 18b, 18c, 18d, 18d′ Moveable braided wire
20, 20a, 20b, 20c, 20d Thermal and magnetic release
22, 22a, 22b, 22c, 22d Tripping coil
23c Guide sleeve
24, 24a, 24b, 24c, 24d Tripping armature
124, 124a, 124b, 124c, 124d First, magnetic tripping armature part
125, 125a, 125b, 125c, 125d Connection point
224, 224a, 224b, 224c, 224d Second, thermal tripping armature part
24′, 24b′, 24d′ Fixed end of the tripping armature
24″, 24b″, 24c″, 24d″ Moveable end of the tripping armature
25, 25d Notch
26, 26a, 26b, 26c, 26d Plunger
28, 28a, 28b, 28c, 28d Tripping-armature mount
30, 30d Tripping lever
30′, 30d′ First free end of the tripping lever
30″, 30d″ Second free end of the tripping lever
32, 32d Tripping-lever mount
33b First limb of the slide 34b
33b′ Second limb of the slide 34b
34, 34b, 34d Slide
35, 35b, 35d Cutout in the slide
36, 36d Switching mechanism
38, 38d Line of action
40, 40a, 40b, 40c, 40d-Yoke
42, 42a, 42b, 42c, 42d Intermediate piece
46d Resetting spring
50d Spring mount
S, L Directional arrow

1. A switching device having a housing and having at least one contact point, which comprises a fixed contact piece and a moveable contact piece, and having a thermal and magnetic release, which comprises a tripping coil and a tripping armature, characterized in that wherein the tripping armature comprises at least two operatively connected tripping armature parts, and the first tripping armature part is formed from a first material having a magnetic shape memory effect, and the second tripping armature part is formed from a bimetallic strip or from a material having a thermal shape memory effect or from a material having a combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open.

2. The switching device as claimed in claim 1, wherein the first tripping armature part is formed from a ferromagnetic shape memory alloy consisting of nickel, manganese and gallium.

3. The switching device as claimed in claim 1, wherein the first and second tripping armature parts are formed from ferromagnetic shape memory alloys of different compositions comprising nickel, manganese and gallium.

4. The switching device as claimed in claim 1, wherein the first and second tripping armature parts are in the form of elongate components, the first tripping armature part, under the influence of the magnetic field of the tripping coil in the event of a short-circuit current, and the second tripping armature part, under the influence of an increase in temperature brought about by overcurrent, being extended in the direction of their longitudinal axis.

5. The switching device as claimed in claim 1, wherein the first and second tripping armature parts are in the form of bars, the first tripping armature part, under the influence of the magnetic field of the tripping coil in the event of a short-circuit current, and the second tripping armature part, under the influence of an increase in temperature brought about by overcurrent, being bent.

6. The switching device as claimed in claim 1, wherein the first and second tripping armature parts are helical, the first tripping armature part, under the influence of the magnetic field of the tripping coil in the event of a short-circuit current, and the second tripping armature part, under the influence of an increase in temperature brought about by overcurrent, being extended in the direction of the longitudinal axis of the helix.

7. The switching device as claimed in claim 1, wherein the tripping armature is surrounded by the tripping coil.

8. The switching device as claimed in claim 1, wherein the tripping armature is fitted outside the coil in its vicinity.

9. The switching device as claimed in claim 1, wherein the increase in temperature of the tripping armature is brought about in the event of an overcurrent by means of indirect heating by the tripping coil carrying the overcurrent.

10. The switching device as claimed in claim 1, wherein the increase in temperature of the tripping armature is brought about in the event of an overcurrent by means of direct heating owing to the overcurrent flowing through the tripping armature.

11. The switching device as claimed in claim 1, wherein the tripping armature is held at a first end in a mount, which is connected to the housing.

12. The switching device as claimed in claim 1, wherein the tripping armature is operatively connected at its second end to a plunger.

13. The use of a material having a magnetic shape memory effect in a thermal and electromagnetic release, which comprises a tripping coil and a tripping armature, which comprises two operatively connected tripping armature parts, for a switching device, wherein a first tripping armature part of the release is formed from the material having the magnetic shape memory effect, and a second tripping armature part is formed from a bimetallic strip or from a material having a thermal shape memory effect or from a material having a combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open.

14. The use of a material having a magnetic shape memory effect as claimed in claim 13, comprising a ferromagnetic shape memory alloy formed of nickel, manganese and gallium.

15. The use of a material having a magnetic shape memory effect as claimed in claim 14, wherein the first and second tripping armature parts are formed from ferromagnetic shape memory alloys of different compositions comprising nickel, manganese and gallium.

16. The use of a material having a magnetic shape memory effect for short-circuit current and overcurrent tripping in a switching device comprising a tripping coil and a thermal and electromagnetic release, wherein a first tripping armature part of the tripping armature, which comprises two operatively connected tripping armature parts, is formed from the material having the magnetic shape memory effect, and a second tripping armature part of the tripping armature, which comprises two operatively connected tripping armature parts, is formed from a bimetallic strip or from a material having a thermal shape memory effect or from a material having a combined thermal and magnetic shape memory effect, the tripping armature, both under the influence of the magnetic field of the tripping coil in the event of a short-circuit current and under the influence of an increase in temperature brought about by overcurrent, being deformed and, as a result, the contact point being caused to open.

17. The use of a material having a magnetic shape memory effect for short-circuit current and overcurrent tripping as claimed in claim 16, comprising a ferromagnetic shape memory alloy formed of nickel, manganese and gallium.

18. The use of a material having a magnetic shape memory effect for short-circuit current and overcurrent tripping as claimed in claim 17, comprising ferromagnetic shape memory alloys formed of nickel, manganese and gallium and having different compositions for forming the first and second tripping armature parts.

19. A thermal and magnetic release arrangement for a switching device, the release arrangement comprising:
a tripping coil, and
a tripping armature having at least two operatively connected tripping armature parts, comprising
a first tripping armature part being formed from a first material having a magnetic shape memory effect, and
a second tripping armature part being formed from a bimetallic strip or from a material having a thermal shape memory effect or from a material having a combined thermal and magnetic shape memory effect, wherein the tripping armature, in the event of a short-circuit current or overcurrent, becomes deformed to cause the release arrangement to trip.
